(19) United States
(12) Patent Application Publication
(10) Pub. No.: US 2008/0158868 A1
(43) Pub. Date: Jul. 3, 2008

(54) Transmission-line holding device

(76) Inventor: Dan-Ji Wu, Zhonghe City (TW)

Correspondence Address: TROXELL LAW OFFICE PLLC, SUITE 1404, 5205 LEESBURG PIKE, FALLS CHURCH, VA, 22041, US

(21) Appl. No.: 11/892,409

(22) Filed: Aug. 22, 2007

(30) Foreign Application Priority Data
Aug. 25, 2006 (TW) 095215114

(51) Int. Cl. F21L 4/04; A44B 21/00

(52) U.S. Cl. 362/208; 24/265 EC

(57) ABSTRACT

A transmission-line holding device comprises: a base, being a U-shaped base encircling a semi-opened internal space which is constructed from a horizontal board and a pair of vertical boards; a terminal positioning structure, settled between the two vertical boards for positioning the terminal connectors at a front end and a rear end of the transmission line inside of the internal space of the base; and a mating structure, arranged behind each of the terminal connectors of the transmission line, respectively. Thereupon, the terminal connectors can be retained inside of the base by coupling the mating structures and the terminal positioning structure mutually, so as to provide the advantages of getting the transmission line ordered, stored, and carried conveniently.

### BACKGROUND OF THE INVENTION

1. Technical Field

The present invention relates to holding devices for transmission lines and, more particularly, to a transmission-line holding device facilitating storing and carrying a transmission line.

2. Description of Related Art

With the vigorous development of technology, novel consumer electronics are introduced unceasingly and our daily life has been filled with various multimedia products. For instances, newly designed MP3 players, digital cameras, and video cameras are presented to our life incessantly, and thus modern people more and more lean on such electronic products. While “digital life” gets more popularized, an increasing amount of digital data has to be stored. Thus, the frequency of exporting digital data from one electronic device to another electronic device or to a personal computer is increasing (as shown in FIG. 1); therefore, a transmission line L has become one of the indispensable tools for data transmission. The conventional transmission line L is typically connected between electronic devices by means of two terminal connectors L1 and L2 provided at a front end and a rear end thereof, respectively. The shape and size of the terminal connectors, and the amount of conducting wires inside the transmission line are subject to the specification of the terminal connectors and the interface where the terminal connectors are applied. For example, when the terminal connectors are for the application of USB interface, there are at least four conducting wires (not shown in the drawings) inside of the transmission line L and the terminal connectors implemented has the size and dimensions conform to the acknowledged hardware standard for the USB interface.

However, when people are using electronic products outdoors, they seldom consider the possible necessity of data transmission, thus often ending up not remembering to carry transmission lines with them. Consequently, when one electronic device is fully loaded with data but cannot be transmitted to a personal computer or another electronic device due to the lack of a transmission line, the electronic device is incapable of storing more data because the memory thereof is used up. Alternatively, when people remember to carry the transmission lines with them, because there is a lack of wire-collecting or wire-holding devices, problems such as tangling or loss of the transmission lines may emerge.

Hence, it is the attempt of the present invention to facilitate efficient storage of transmission lines for the purpose of easy carrying the same.

### SUMMARY OF THE INVENTION

The present invention has been accomplished under these circumstances in view. It is one objective of the present invention to provide a transmission-line holding device, which is provided with positioning structures for retaining front and rear terminal connectors of a transmission line. By positioning the front and rear terminal connectors with the disclosed positioning structures, respectively, the transmission line can be looped so as to provide the advantages of getting the transmission line ordered, stored, and carried conveniently.

To achieve these and other objectives of the present invention, the transmission-line holding device of the present invention comprises:
a base, being a U-shaped base encircling a semi-opened internal space which is constructed from a horizontal board and a pair of vertical boards;
a terminal positioning structure, settled between the two vertical boards for positioning terminal connectors at a front end and a rear end of a transmission line inside of the internal space of the base; and
a mating structure, arranged behind each said terminal connectors of the transmission line in correspondence to the terminal positioning structure, respectively.

Thereupon, by coupling the mating structures and the terminal positioning structure mutually, the terminal connectors can be retained inside of the base so as to achieve the purposes of getting the transmission line ordered, stored and carried conveniently.

According to the previously described transmission-line holding device, the terminal positioning structure comprises an inlaid board pivotally connected between the two vertical boards and a lower retaining board aligned to one end of the inlaid board.

The lower retaining board is provided with a pair of lower retaining recesses. When the inlaid board is not parallel to the horizontal board, the lower retaining recesses are opened for accommodating the mating structures behind the terminal connectors, respectively.

Moreover, when the inlaid board is parallel to the horizontal board, the inlaid board and the retaining recesses collectively form two retaining apertures so as to simultaneously retain the terminal connectors at the front and rear ends of the transmission line at one side of the base, so that the transmission line is looped and the purposes of getting the transmission line ordered, stored, and carried conveniently can be achieved.

According to the previously described transmission-line holding device, the transmission line can be used to string a plurality of keys and then have the front and rear end thereof fastened at the side of the base to form a looped shape.

According to the previously described transmission-line holding device, the transmission line and terminal connectors thereof may be those for the application of Universal Serial Bus (USB) or IEEE1394 or DC power connection, which are not limited in the present invention.

According to the previously described transmission-line holding device, a retaining block can be further jammed between a rear end of the inlaid board and the base for retaining the inlaid board parallel to the horizontal board and in turn retaining the terminal connectors inside the base.

### BRIEF DESCRIPTION OF THE DRAWINGS

The invention as well as a preferred mode of use, further objectives and advantages thereof, will best be understood by reference to the following detailed description of an illustrative embodiment when read in conjunction with the accompanying drawings, wherein:

FIG. 1 is a schematic drawing showing a conventional transmission line connected between two electronic devices;

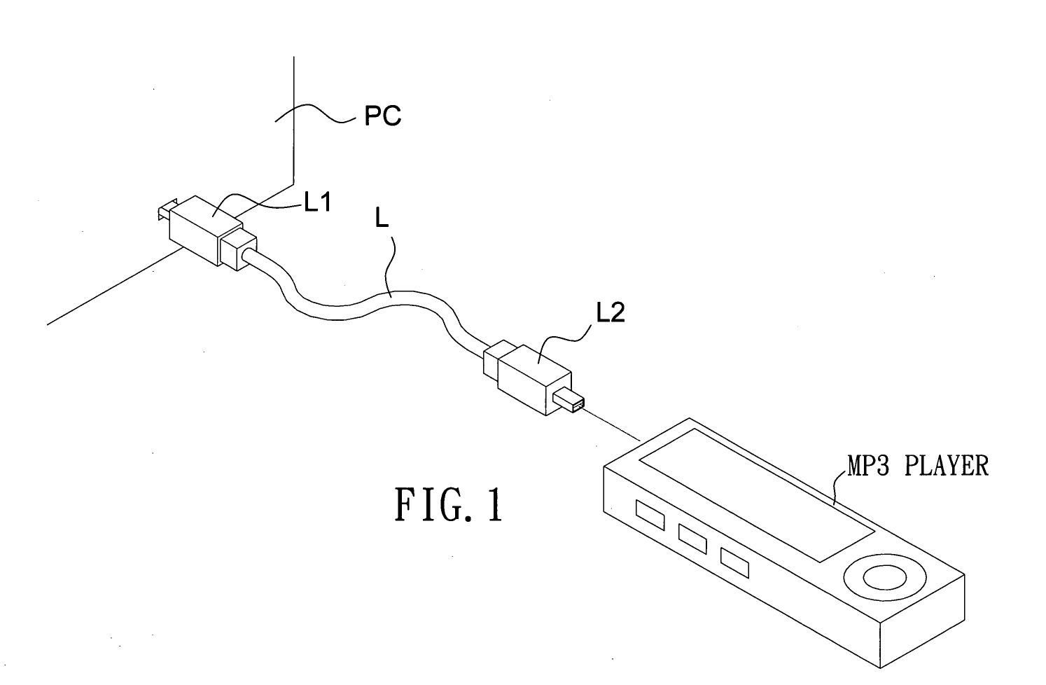

FIG. 2 is an exploded view of a transmission-line holding device according to the present invention;

FIG. 3 is another exploded view of the transmission-line holding device according to the present invention;

FIG. 4 is a sectional view of the transmission-line holding device according to the present invention, showing that the inlaid board is not parallel to the horizontal board;

FIG. 5 is another sectional view of the transmission-line holding device according to the present invention, showing that the inlaid board is parallel to the horizontal board; and

FIG. 6 is a perspective view of the transmission-line holding device according to the present invention, showing that a plurality of keys are strung by the transmission line.

### DETAILED DESCRIPTION OF THE PREFERRED EMBODIMENT

It is to be noted that a transmission line and terminal connector thereof described herein may be of all specifications for all signal transmission interface, such as Universal Serial Bus (USB) or IEEE1394, or DC power connection, which are not limited by the present invention. Any transmission line and terminal connectors thereof that can be used for signal or power transmission of electronic products can be applied as a transmission line and terminal connectors of the present invention.

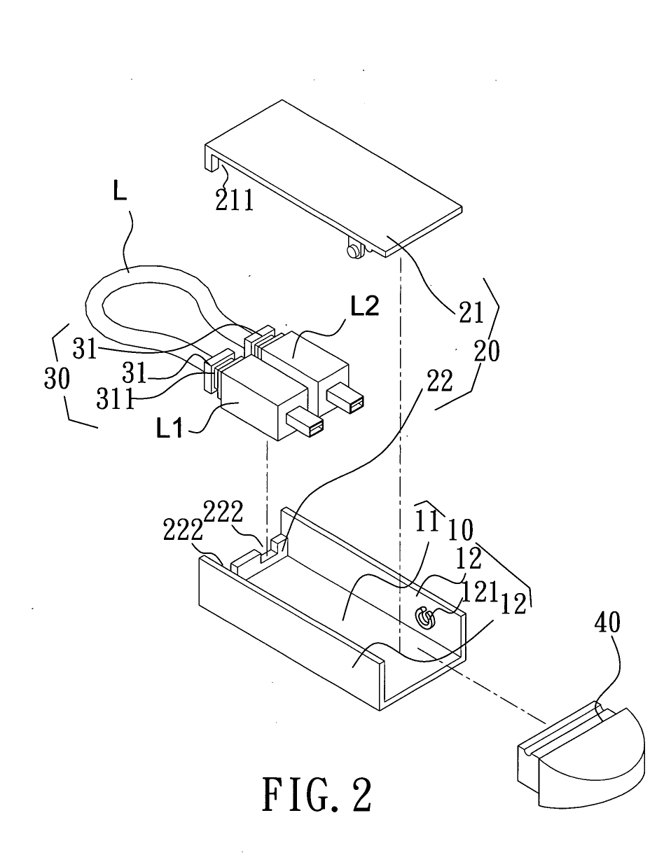

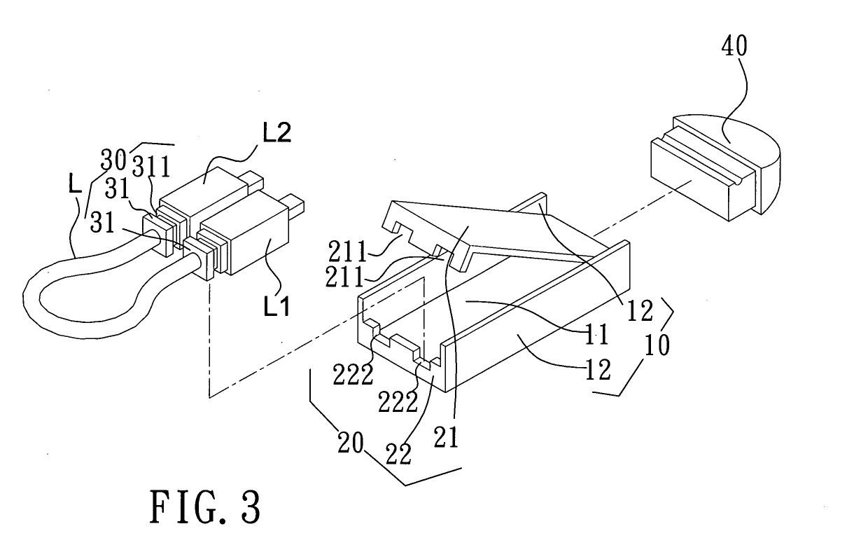

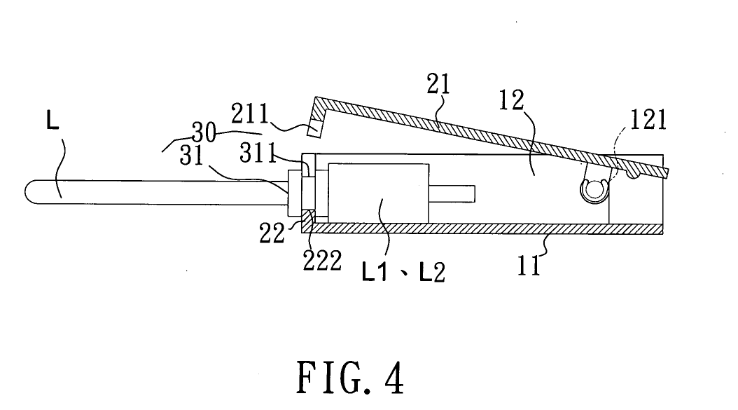

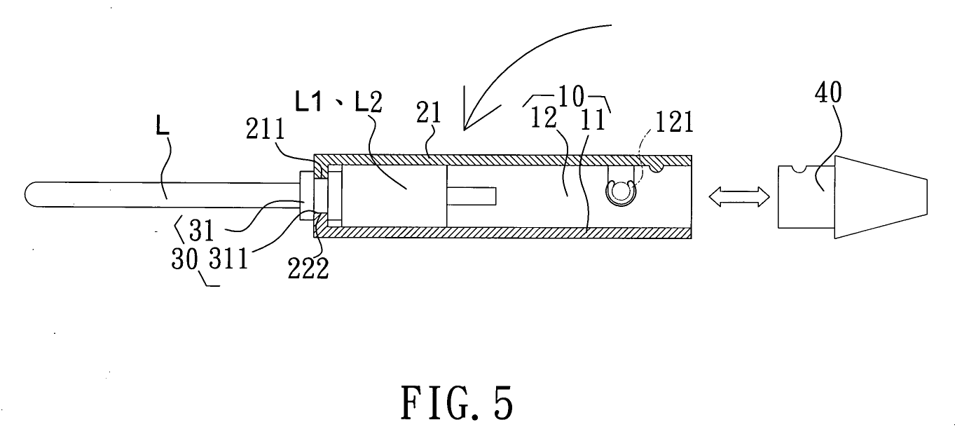

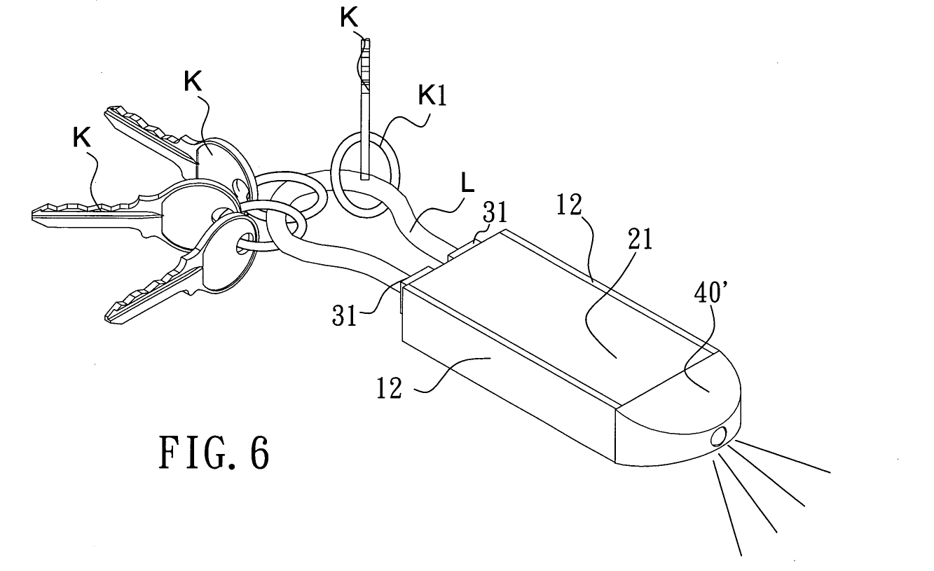

Please refer to FIGS. 2 through 6, wherein FIG. 2 is an exploded view of a transmission-line holding device according to the present invention; FIG. 3 is another exploded view of the transmission-line holding device according to the present invention; FIG. 4 is a sectional view of the transmission-line holding device according to the present invention, showing that the inlaid board is not parallel to the horizontal board; FIG. 5 is another sectional view of the transmission-line holding device according to the present invention, showing that the inlaid board is parallel to the horizontal board; and FIG. 6 is a perspective view of the transmission-line holding device according to the present invention, showing that a plurality of keys are strung by the transmission line.

As shown in the drawings, the transmission-line holding device of the present invention primarily comprises a base 10, a terminal positioning structure 20 and a pair of mating structures 30 arranged at front and rear ends of a transmission line L, respectively (as shown in FIGS. 2 and 3). The terminal positioning structure 20 is complementary to the mating structures 30, so that terminal connectors L1 and L2 of the transmission line L can be retained inside the base 10 to form the transmission line L into a looped shape, so as to provide the advantages of getting the transmission line ordered, stored, and carried conveniently.

The base 10 includes a horizontal board 11 and a pair of vertical boards 12, wherein the vertical boards 12 are deposited at two opposite sides of the horizontal board 11 so as to form a U-shaped base encircling a semi-opened internal space.

The terminal positioning structure 20 is settled between the two vertical boards 12 of the base 10 for positioning the terminal connectors L1 and L2 of the transmission line L inside of the internal space of the base 10 (as shown in FIG. 4). The terminal positioning structure 20 comprises an inlaid board 21 and a lower retaining board 22. The inlaid board 21 is pivotally connected between the two vertical boards 12, and is provided with a pair of upper retaining recesses 211 at a front end thereof. The lower retaining board 22 is deposited between the two vertical boards 12 aligned with the front end of the inlaid board 21, and is formed with a pair of lower retaining recesses 222 communicated to the upper retaining recesses 211 so as to fasten the terminal connectors L1 and L2 at the base 10.

Each of the mating structures 30 is arranged behind the terminal connector L1 or L2 of the transmission line L. According to the present embodiment, each of the mating structures 30 is a block 31 sheathing around surface of the transmission line L. A front end of the block 31 may be connected or formed integrally with a rear end of the terminal connector L1 or L2, and the arrangement is not limited in any ways in the present invention. A neck 311 is peripherally deposited at surface of the block 31 for allowing the upper and lower retaining recesses 211 and 222 to couple with upper and lower surfaces thereof (as shown in FIG. 5), so that the terminal connectors L1 and L2 can be retained inside of the base 10. For the purpose of coupling, the neck 311 must have a sectional shape complementary to that of a retaining aperture collectively formed by the upper retaining recess 211 and lower retaining recess 222. Further, when the inlaid board 21 is not parallel to the horizontal board 11 (as shown in FIG. 4), the lower retaining recesses 222 are opened, and capable of accommodating the necks 311 behind the terminal connectors L1 and L2, respectively, so that the terminal connectors L1 and L2 can be positioned abreast inside of the internal space of the base 10. Afterward, the inlaid board 21 can be pivoted to a position parallel to the horizontal board 11 (as shown in FIG. 5), so that the upper retaining recesses 211 are coupled with the necks 311 to further retain the terminal connectors L1 and L2 inside of the base 10 and bend the transmission line into a looped shape.

When the upper retaining recesses 211 and lower retaining recesses 222 are coupled with necks 311, a retaining block 40 can be further jammed between a rear end of the inlaid board 21 and the base 10. The retaining block 40 not only retains the inlaid board 21 parallel to the horizontal board 11 (as shown in FIG. 5), but also seals the internal space of the base 10 as a sealed room for the purpose of accommodating articles having small volume. Besides, the retaining block 40 may be equipped therein with a light module 40′ or other modules with specific functions according to the need of users. Thereupon, the disclosed subject matter can be implemented as a key chain by stringing a plurality of keys on the looped transmission line L (as shown in FIG. 6), and can provide illumination in virtue of the light module 40′ or other additional functions contributed by other modules attached to the base 10.

Please refer to FIG. 2 again. The pivotal connection between a pivot of the horizontal board 11 and the inlaid board 21 can be realized through a pair of C-shaped protrusions 121 provided at surfaces of the vertical boards 12 for receiving the pivot of the inlaid board 21 inserted into pivotal spaces formed therein through openings thereof. To replace the inlaid board 21, the pivot can be easily disassembled from the C-shaped protrusions 121 through the openings thereof and another inlaid board 21 can be reassembled to the C-shaped protrusions 121 easily. By using the aforementioned pivotal connection, users can replace various inlaid boards 21 with diverse surface patterns or colors according to their desires.

Although a particular embodiment of the invention has been described in detail for purposes of illustration, it will be understood by one of ordinary skill in the art that numerous variations will be possible to the disclosed embodiments without going outside the scope of the invention as disclosed in the claims.

What is claimed is:

1. A transmission-line holding device, comprising:
a base, being a U-shaped base encircling a semi-opened internal space which is constructed from a horizontal board and a pair of vertical boards;
a terminal positioning structure, settled between the two vertical boards for positioning terminal connectors at a front end and rear end of a transmission line inside the internal space of the base; and
a mating structure, arranged behind each of the terminal connectors of the transmission line in correspondence to the terminal positioning structure, respectively.

2. The transmission-line holding device of claim 1, wherein the terminal positioning structure comprises:
an inlaid board, pivotally connected between the two vertical boards and having at least one pair of upper retaining recesses at a front end thereof; and
a lower retaining board, positioned between the two vertical boards and having lower retaining recesses aligned to the upper retaining recesses.

3. The transmission-line holding device of claim 1, wherein the transmission line and terminal connectors can be those for application of Universal Serial Bus (USB) or IEEE1394 or DC power connection.

4. The transmission-line holding device of claim 1, wherein a retaining block can be further jammed between a rear end of the inlaid board and the base.

5. The transmission-line holding device of claim 4, wherein a light module is provided inside of the retaining block.

6. The transmission-line holding device of claim 4, wherein a module with a specific function is provided in the retaining block.

7. The transmission-line holding device of claim 1, wherein the mating structure comprises a block disposed at a rear end of the terminal connectors, and the block has a neck peripherally deposited at surface thereof.

8. The transmission-line holding device of claim 7, wherein the neck has a sectional shape complementary to that of a retaining aperture collectively formed by the upper retaining recess and the lower retaining recess.
